(19) United States
(12) Patent Application Publication
(10) Pub. No.: US 2016/0203056 A1
(43) Pub. Date: Jul. 14, 2016

(54) Apparatus, snapshot management method, and recording medium

(71) Applicant: FUJITSU LIMITED, Kawasaki-shi (JP)

(72) Inventors: Toshihiro Shimizu, Sagamihara (JP); Takeshi Yasuie, Kawasaki (JP); Atsuji Sekiguchi, Kawasaki (JP)

(73) Assignee: FUJITSU LIMITED, Kawasaki-shi (JP)

(21) Appl. No.: 14/757,534

(22) Filed: Dec. 23, 2015

(30) Foreign Application Priority Data
Jan. 9, 2015 (JP) 2015-003703

(51) Int. Cl. G06F 11/14

(52) U.S. Cl. CPC G06F 11/1453; G06F 11/1464; G06F 2201/84

(57) ABSTRACT

An apparatus includes: a first memory configured to store a plurality of snapshots of a database; a second memory configured to store correspondence information for each of processing requests to the database, the correspondence information including a time at which each of the processing requests is accepted by the database in association with a time period taken for processing each of the processing requests; and a processor configured to: identify a total time period to process processing requests received by the database from a first time at which a first snapshot is obtained to a second time at which a second snapshot is obtained, the first snapshot and the second snapshot being included in the plurality of snapshots; decide a snapshot to be deleted from the plurality of snapshots based on the identified total time period; and delete the decided snapshot from the first memory.

### CROSS-REFERENCE TO RELATED APPLICATION

This application is based upon and claims the benefit of priority of the prior Japanese Patent Application No. 2015-003703, filed on Jan. 9, 2015, the entire contents of which are incorporated herein by reference.

### FIELD

The embodiment discussed herein is related to an apparatus, a snapshot management method, and a recording medium.

### BACKGROUND

Conventionally, there is a technique in which a snapshot obtained by duplicating a database at a certain time is created. By accumulating snapshots at short time intervals, time points at each of which a restorable database exists can be increased. On the other hand, because the storage area to accumulate the snapshots is finite, there is a limit to the number of snapshots that can be accumulated. As a related art, there is e.g. a technique in which, when a failure occurs, a virtual machine is restored to the acquisition time point of a snapshot by using the snapshot of the virtual machine and input logs from the acquisition time point to the time point of the failure occurrence included in communication logs are populated into the restored virtual machine in chronological order. Furthermore, there is a technique in which header information of two packets transmitted to a standby server is properly rewritten so that the time interval of two packets transmitted to a main server may become identical to the time interval of the two packets transmitted to the standby server.

As related-art documents, there are Japanese Laid-open Patent Publication No. 2009-080705 and Japanese Laid-open Patent Publication No. 2011-199680.

However, according to the related art, it is difficult to determine which snapshot is to be deleted from accumulated plural snapshots. For example, if merely any snapshot is deleted from plural snapshots, possibly increase in the restoring time of the database is caused although the amount of accumulation of the snapshots can be reduced.

### SUMMARY

According to an aspect of the invention, an apparatus includes: a first memory configured to store a plurality of snapshots of a database, each of the plurality of snapshots being obtained by duplicating contents of the database at a different time; a second memory configured to store correspondence information for each of processing requests to the database, the correspondence information including a time at which each of the processing requests is accepted by the database in association with a time period taken for processing each of the processing requests; and a processor coupled to the first memory and the second memory and configured to: identify a total time period to process processing requests received by the database from a first time at which a first snapshot is obtained to a second time at which a second snapshot is obtained, the first snapshot and the second snapshot being included in the plurality of snapshots; decide a snapshot to be deleted from the plurality of snapshots based on the identified total time period; and delete the decided snapshot from the first memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an operation example of a management device according to a present embodiment;

FIG. 2 illustrates a configuration example of an access reproduction system;

FIG. 3 illustrates a hardware configuration example of a computer used in the present embodiment;

FIG. 4 illustrates an operation example of an access reproduction system;

FIG. 5 illustrates one example of timing specifying of access reproduction;

FIG. 6 is a block diagram illustrating a functional configuration example of a database (DB) restoring device;

FIG. 7 illustrates one example of stored contents of snapshot use information;

FIG. 8 illustrates an example of decision of snapshots to be deleted;

FIG. 9 illustrates one example of a method for identifying creation time of a snapshot;

FIG. 10 illustrates one example of a speculative method for creating snapshots;

FIG. 11 is a flowchart illustrating one example of a procedure of access reproduction processing;

FIG. 12 is a flowchart illustrating one example of a procedure of deleted-snapshot decision processing;

FIG. 13 is a flowchart (first) illustrating one example of a procedure of speculative snapshot creation processing; and

FIG. 14 is a flowchart (second) illustrating one example of a procedure of speculative snapshot creation processing.

### DESCRIPTION OF EMBODIMENT

One aspect of the embodiment of a snapshot management method, a system, and a recording medium to be disclosed intends to suppress increase in the restoring time of a database and reduce the amount of accumulation of snapshots. The embodiment of the disclosure will be described in detail below with reference to the accompanying drawings.

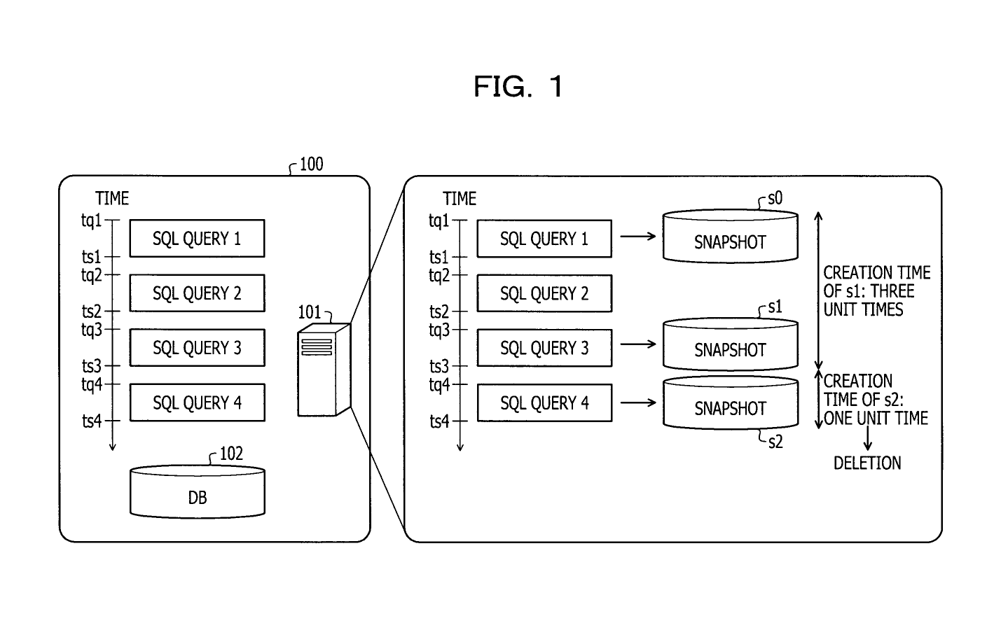

FIG. 1 is an explanatory diagram illustrating an operation example of a management device according to a present embodiment. A management device 101 included in a system 100 is a computer that manages snapshots of a DB 102. The system 100 further includes the DB 102. The snapshot is what is obtained by duplicating the contents of a DB at a certain time. By saving the snapshot, if data of the DB is lost after the saving of the snapshot, the data at the duplication time point can be restored by using the snapshot. Hereinafter, when a description is made as “the time of a snapshot,” this means a certain time at which the contents of a DB are duplicated in order to create this snapshot.

The DB 102 accepts a processing request. When accepting a processing request, the DB 102 executes processing corresponding to the processing request. The processing request is, for example, described by a database query language, e.g. an SQL query. Hereinafter, suppose that the processing request is the SQL query. Furthermore, for example if the SQL query is a query to make reference to the DB 102 and return data according with a condition, the processing corresponding to the SQL query is processing of retrieving the data according with the condition and returning the data according with the condition to the request source as a response. Moreover, for example if the SQL query is a query to update the data of the DB 102, the processing corresponding to the SQL query is processing of updating the data of the DB 102 and returning the update result.

By saving the issued SQL query, the contents of not only the DB at the time of a snapshot but also the DB at an arbitrary time can be restored if the SQL query is issued to the DB which is restored from the snapshot.

Here, the restoring time of the DB can be shortened as the number of saved snapshots is increased. However, there is a limit to the number of snapshots that can be saved and therefore the snapshot is deleted. However, it is difficult to reduce the data amount of the snapshot with suppression of increase in the restoring time of the database. For example, if merely any snapshot is deleted from plural snapshots, possibly increase in the restoring time of the database is caused although the amount of accumulation of the snapshots can be reduced.

Therefore, the management device 101 in the present embodiment decides the snapshot to be deleted from plural snapshots on the basis of the processing time of the SQL query received between the creation time points of the respective snapshots. This allows the management device 101 to delete a snapshot that can be quickly created to suppress increase in the restoring time of the DB while reducing the amount of accumulation of the snapshots. Although the management device 101 decides the snapshot to be deleted in the present embodiment, the management device 101 may decide the snapshot to be left.

The specific operation of the management device 101 will be described by using FIG. 1. The example of FIG. 1 is in a state in which SQL queries 1 to 4 are issued to the DB 102. The SQL queries 1 to 4 are issued at times tq1 to tq4, respectively. Furthermore, the DB 102 makes responses to the SQL queries 1 to 4 at times ts1 to ts4, respectively. Here, the order of the times tq1 to tq4 and ts1 to ts4 is the time tq1, ts1, tq2, ts2, tq3, ts3, tq4, and ts4 from the oldest time. Therefore, the times taken for processing corresponding to the SQL queries 1 to 4 are the time from the time tq1 to the time ts1, the time from the time tq2 to the time ts2, the time from the time tq3 to the time ts3, and the time from the time tq4 to the time ts4, respectively. Here, for simplification of description, the times from the times tq1 to tq4 to the times ts1 to ts4, respectively, are all identical and will be referred to as “one unit time” in the description of FIG. 1. Hereinafter, the time taken for the processing corresponding to the SQL query will be referred to simply as the “SQL query processing time”.

The management device 101 stores correspondence information in which the times of the SQL queries 1 to 4 are associated with the processing times of the SQL queries 1 to 4. Here, the times of the SQL queries 1 to 4 may be either the request times of the SQL queries 1 to 4 or the response times.

Furthermore, suppose that the management device 101 manages snapshots s0 to s2 and, in FIG. 1, the snapshots s1 and s2 are deemed as deletion candidates and either one is deleted. The snapshot s0 is obtained by duplicating the contents of the DB 102 at the time tq1. Furthermore, the snapshot s1 is obtained by duplicating the contents of the DB 102 at the time ts3. In addition, the snapshot s2 is obtained by duplicating the contents of the DB 102 at the time ts4.

The management device 101 refers to the correspondence information and identifies the processing time of the SQL query accepted by the DB 102 from the time of another snapshot different from one snapshot of the snapshots s1 and s2 by the time of this one snapshot. The processing time of the SQL query accepted by the DB 102 from the time of another snapshot different from one snapshot of the snapshots s1 and s2 by the time of this one snapshot is the creation time of this one snapshot.

The management device 101 may identify the processing time of the SQL query about one snapshot or may identify the processing time of the SQL query about all of the snapshots of the deletion candidates. Furthermore, another snapshot different from the one snapshot may be any snapshot as long as this snapshot is a snapshot previous to the one snapshot. However, it is preferable that this snapshot is a snapshot immediately previous to the one snapshot.

For example, in the example of FIG. 1, the management device 101 identifies the processing time of the SQL query in the time from the time tq1 of the snapshot s0 to the time ts3 of the snapshot s1, i.e. the creation time of the snapshot s1, as three unit times. Similarly, the management device 101 identifies the processing time of the SQL query in the time from the time ts3 of the snapshot 51 to the time ts4 of the snapshot s2, i.e. the creation time of the snapshot s2, as one unit time.

Then, the management device 101 decides the snapshot to be deleted from plural snapshots of the deletion candidates on the basis of the identified creation time of the snapshot. For example, when the creation time is identified about a certain snapshot, the management device 101 decides the certain snapshot as the snapshot to be deleted if the identified creation time is shorter than a predetermined threshold. Furthermore, when the creation times are identified about all of the snapshots of the deletion candidates, the management device 101 decides the snapshot having the shortest creation time among the identified creation times as the snapshot to be deleted.

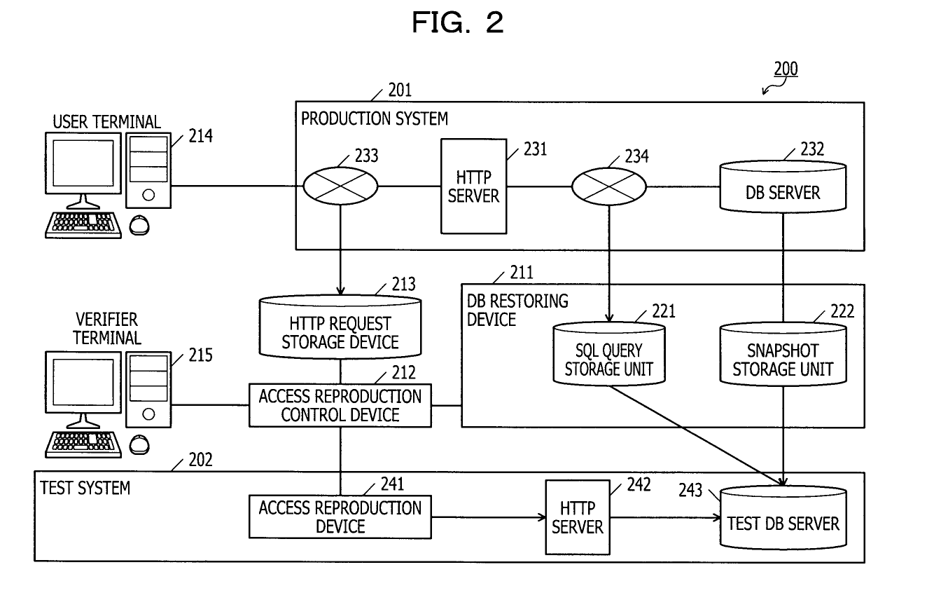

In the example of FIG. 1, the creation time of the snapshot s2 is one unit time and is the shortest. Therefore, the management device 101 decides the snapshot s2 as the snapshot to be deleted. Next, an example in which the system 100 is applied to an access reproduction system will be described by using FIG. 2.

FIG. 2 is an explanatory diagram illustrating a configuration example of an access reproduction system. An access reproduction system 200 is a system that reproduces a state at any time point in a production system 201 by a test system 202. The access reproduction system 200 includes the production system 201, the test system 202, a DB restoring device 211, an access reproduction control device 212, a hypertext transfer protocol (HTTP) request storage device 213, a user terminal 214, and a verifier terminal 215.

The DB restoring device 211 includes an SQL query storage unit 221 and a snapshot storage unit 222. The production system 201 includes an HTTP server 231 and a DB server 232. Furthermore, the production system 201 includes networks 233 and 234. The HTTP request storage device 213, the HTTP server 231, and the user terminal 214 are coupled by the network 233. The HTTP server 231, the DB server 232, and the DB restoring device 211 are coupled by the network 234. The test system 202 includes an access reproduction device 241, an HTTP server 242, and a test DB server 243.

Here, the DB restoring device 211 is equivalent to the management device 101 illustrated in FIG. 1. Furthermore, the DB server 232 is equivalent to the DB 102 illustrated in FIG. 1. Moreover, the SQL query storage unit 221 is equivalent to the correspondence information illustrated in FIG. 1.

The production system 201 is a system that offers some kind of service. For example, in the example of FIG. 2, the production system 201 offers a Web service based on the HTTP. The user terminal 214 is a device operated by a user who uses the production system 201. For example, when the user terminal 214 transmits an HTTP request to the production system 201, the network 233 transmits the received HTTP request to each of the HTTP server 231 and the HTTP request storage device 213.

The HTTP server 231 generates an SQL query from the received HTTP request and transmits the SQL query to the network 234. The network 234 transmits the received SQL query to each of the DB server 232 and the DB restoring device 211. The DB restoring device 211 stores the received SQL query in the SQL query storage unit 221.

The DB server 232 executes processing corresponding to the received SQL query. Furthermore, the DB server 232 creates a snapshot in a time zone in which less access is made, such as at the time of maintenance, in the night or the like. The snapshot created in the time zone in which less access is made, such as at the time of maintenance, in the night or the like, will be referred to as the “initial snapshot.” The DB server 232 transmits the created snapshot to the DB restoring device 211. The DB restoring device 211 stores the received snapshot in the snapshot storage unit 222. Here, the HTTP requests saved in the HTTP request storage device 213 and the SQL queries saved in the SQL query storage unit 221 may be based on packet capture or may be logs as long as the issuance order can be identified collectively.

The test system 202 is a system that tests the operation of the production system 201. For example, when a trouble occurs in the production system 201, the access reproduction control device 212 receives an instruction to reproduce the state at the time of the occurrence of the trouble from the verifier terminal 215 by operation by a verifier. Then, the access reproduction control device 212 instructs the DB restoring device 211 to reproduce, in the test DB server 243, the contents of the DB server 232 at the time of the occurrence of the trouble in the production system 201.

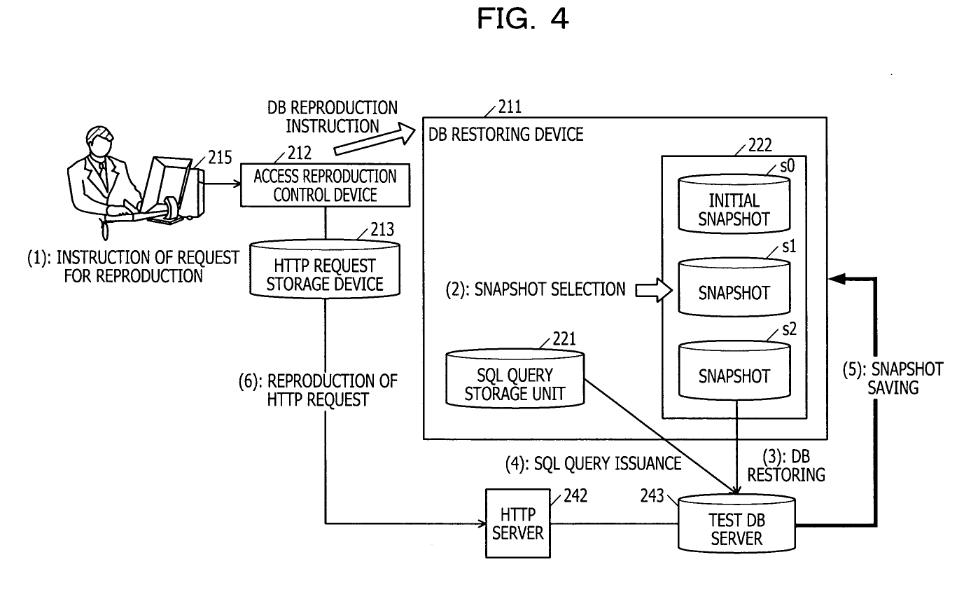

Furthermore, the access reproduction control device 212 instructs the access reproduction device 241 to transmit an HTTP request desired to be reproduced to the HTTP server 242 by using the HTTP request saved in the HTTP request storage device 213. The access reproduction device 241 transmits the HTTP request saved in the HTTP request storage device 213 to the HTTP server 242 while converting the Internet protocol (IP) address and the port number of the HTTP request in conformity with the test system 202. A more detailed operation example will be described with FIG. 4.

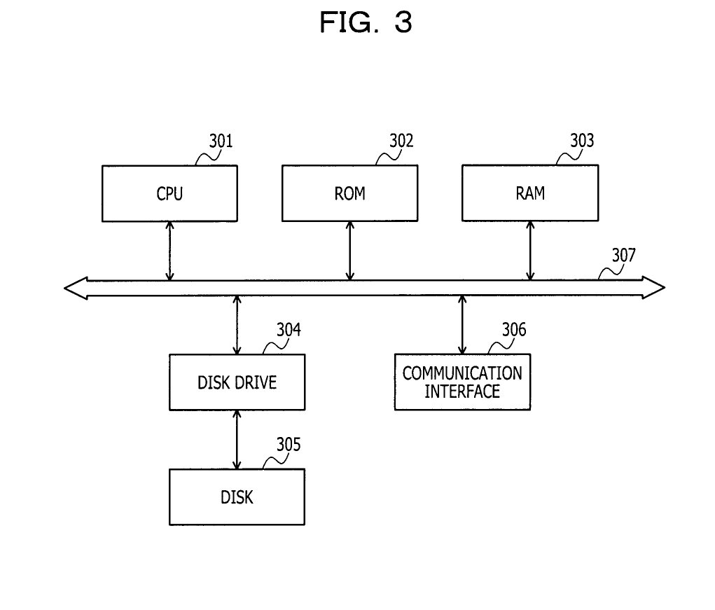

FIG. 3 is an explanatory diagram illustrating a hardware configuration example of a computer used in the present embodiment. In FIG. 3, the hardware configuration of the DB restoring device 211, the access reproduction control device 212, the HTTP server 231, the DB server 232, the access reproduction device 241, the HTTP server 242, and the test DB server 243 is illustrated as the computer used in the present embodiment.

In FIG. 3, the computer includes a central processing unit (CPU) 301, a read only memory (ROM) 302, and a random access memory (RAM) 303. Furthermore, the computer includes a disk drive 304, a disk 305, and a communication interface 306. Moreover, the CPU 301 to the disk drive 304 and the communication interface 306 are coupled to each other by a bus 307.

The CPU 301 is an arithmetic processing device responsible for overall control of the computer. Furthermore, the computer may include plural CPUs. The ROM 302 is a non-volatile memory that stores programs such as a boot program. The RAM 303 is a volatile memory used as a work area of the CPU 301.

The disk drive 304 is a control device that controls reading and writing of data on the disk 305 in accordance with control of the CPU 301. As the disk drive 304, e.g. a magnetic disk drive, an optical disk drive, a solid state drive, or the like can be employed. The disk 305 is a non-volatile memory that stores data written under control by the disk drive 304. For example, if the disk drive 304 is a magnetic disk drive, a magnetic disk can be employed as the disk 305. Furthermore, if the disk drive 304 is an optical disk drive, an optical disk can be employed as the disk 305. In addition, if the disk drive 304 is a solid state drive, a semiconductor memory formed of a semiconductor element, i.e. a so-called semiconductor disk, can be employed as the disk 305.

The communication interface 306 is a control device that is responsible for an interface between a network and the inside and controls input and output of data from and to another device. For example, the communication interface 306 is coupled to another device through a communication line and via a network. As the communication interface 306, e.g. a modem, a local area network (LAN) adaptor, or the like can be employed.

Furthermore, the user terminal 214 and the verifier terminal 215 include hardware such as a display, a keyboard, and a mouse in addition to the hardware illustrated in FIG. 3.

FIG. 4 is an explanatory diagram illustrating an operation example of an access reproduction system. Regarding (1) in FIG. 4, the verifier terminal 215 receives an instruction to reproduce a state at the time of the occurrence of a trouble. Then, the access reproduction control device 212 transmits a DB reproduction instruction to the DB restoring device 211. Here, in the DB reproduction instruction, the time of the database desired to be reproduced is specified.

Next, regarding (2) in FIG. 4, the DB restoring device 211 selects a snapshot to be used for restoring from snapshots saved in the snapshot storage unit 222 on the basis of the DB reproduction instruction. For example, the DB restoring device 211 selects the latest snapshot among the snapshots indicating the states older than the time specified in the DB reproduction instruction. In the example of FIG. 4, the initial snapshot s0 and the snapshots s1 and s2 created by the present embodiment are saved in the snapshot storage unit 222 and the DB restoring device 211 selects the snapshot s1 as the snapshot to be used for restoring.

Then, regarding (3) in FIG. 4, by using the snapshot s1, the DB restoring device 211 restores the contents at the time of the snapshot used for restoring on the test DB server 243.

Next, regarding (4) in FIG. 4, the DB restoring device 211 issues, to the test DB server 243, the SQL queries issued to the DB server 232 from the duplication time point of the snapshot s1 by the time specified in the DB reproduction instruction. Due to (4) in FIG. 4, the contents of the test DB server 243 correspond with the contents of the DB server 232 at the time specified in the DB reproduction instruction. Furthermore, regarding (4) in FIG. 4, if the SQL queries issued to the DB server 232 from the duplication time point of the snapshot s1 by the time specified in the DB reproduction instruction are absent, the access reproduction system 200 does not carry out (4) and (5) in FIG. 4 but carries out (6) in FIG. 4.

Then, regarding (5) in FIG. 4, the test DB server 243 creates a snapshot and transmits the snapshot to the DB restoring device 211. The DB restoring device 211 saves the received snapshot in the snapshot storage unit 222. The reason why (5) in FIG. 4 is carried out is as follows. A trouble readily appears at a place where a trouble is corrected and therefore there is a possibility that the DB restoring device 211 receives a DB reproduction instruction in which the same time is specified again. Therefore, by creating the snapshot corresponding to the time specified once, the DB restoring device 211 does not have to carry out (4) in FIG. 4 when receiving a DB reproduction instruction in which the same time is specified again.

Next, regarding (6) in FIG. 4, the access reproduction control device 212 carries out reproduction of an HTTP request to the HTTP server 242 by using the HTTP request storage device 213.

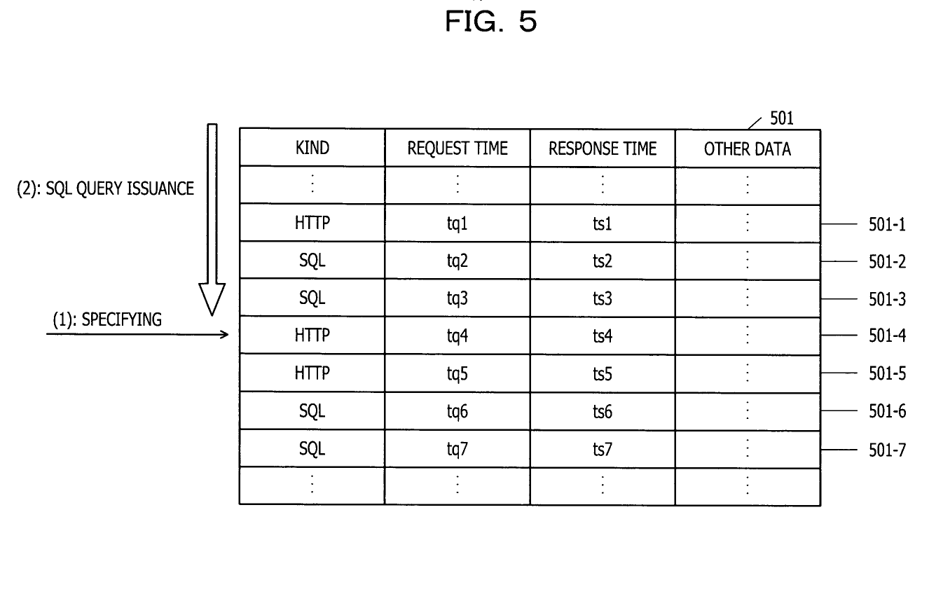

FIG. 5 is an explanatory diagram illustrating one example of timing specifying of access reproduction. In FIG. 5, until what point SQL queries are issued when the DB restoring device 211 receives a DB reproduction instruction will be explained. A table 501 is data in which HTTP requests saved by the HTTP request storage device 213 and SQL queries saved by the SQL query storage unit 221 are lined in chronological order. The table 501 represented in FIG. 5 includes records 501-1 to 501-7. Furthermore, for simplification of description, regarding request times represented by the table 501, suppose that tq1 is the oldest time among tq1 to tq7 and the time becomes newer in ascending order and tq7 is the newest time. Similarly, regarding response times represented by the table 501, suppose that ts1 is the oldest time among ts1 to ts7 and the time becomes newer in ascending order and ts7 is the newest time.

For example, suppose that, in the example of FIG. 5, a user of the verifier terminal 215 wants to reproduce the database at the time point of the HTTP request represented by the record 501-4 as (1) in FIG. 5. In this case, the DB restoring device 211 receives a DB reproduction instruction at the time tq4. Then, the DB restoring device 211 issues the SQL queries of the records 501-2 and 501-3 to the test DB server 243 as (2) in FIG. 5.

(Functional Configuration Example of DB Restoring Device 211)

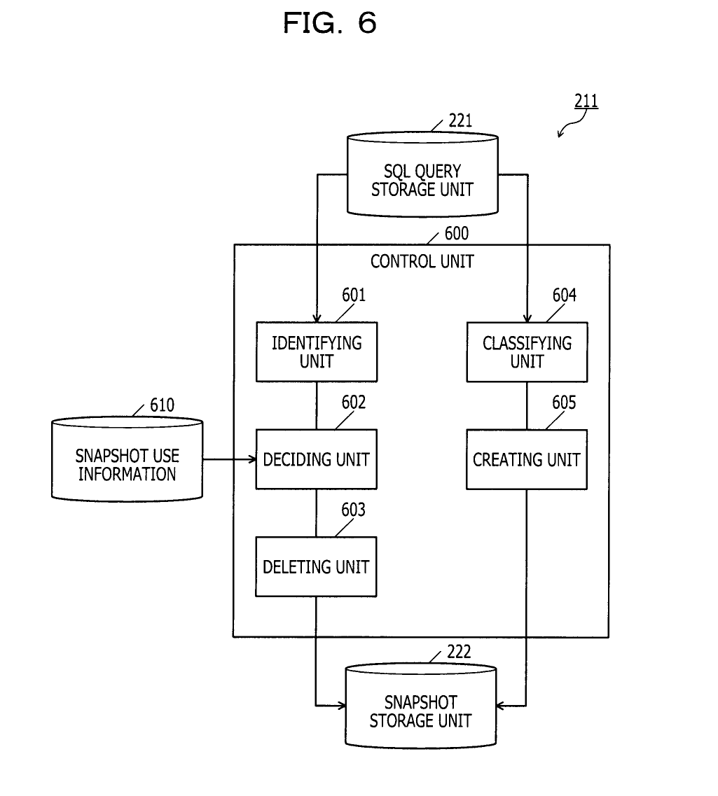

FIG. 6 is a block diagram illustrating a functional configuration example of a DB restoring device. The DB restoring device 211 includes a control unit 600. The control unit 600 includes an identifying unit 601, a deciding unit 602, a deleting unit 603, a classifying unit 604, and a creating unit 605. The control unit 600 implements the functions of the respective units through execution of programs stored in a storage device by the CPU 301. For example, the storage device is e.g. the ROM 302, the RAM 303, the disk 305, or the like illustrated in FIG. 3. Furthermore, processing results of the respective units are stored in a register of the CPU 301, a cache memory of the CPU 301, and so forth.

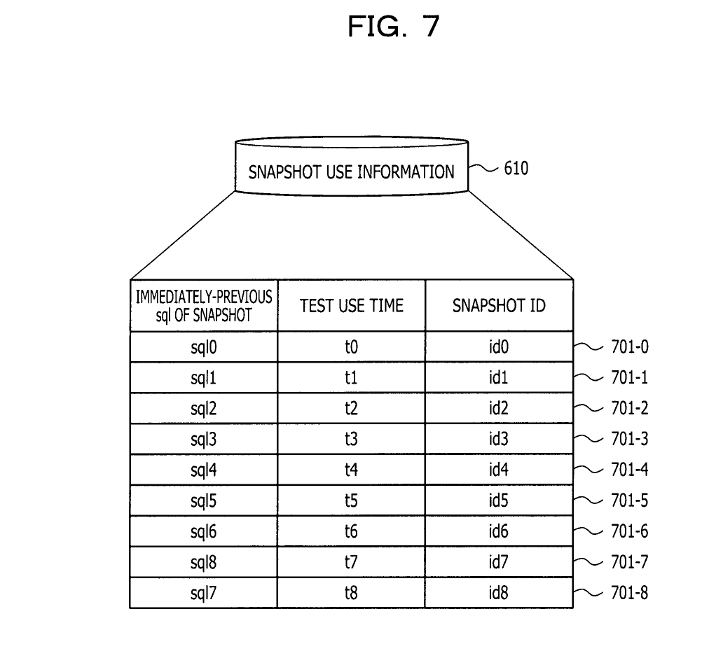

Furthermore, the DB restoring device 211 can access the SQL query storage unit 221, the snapshot storage unit 222, and snapshot use information 610. The SQL query storage unit 221, the snapshot storage unit 222, and the snapshot use information 610 are stored in a storage device such as the RAM 303 or the disk 305. The snapshot storage unit 222 stores the times of SQL queries and the processing times of the SQL queries in association with each other. The snapshot storage unit 222 stores snapshots. The snapshot use information 610 stores information to identify the time when the snapshot stored in the snapshot storage unit 222 is used to restore the contents of the DB server 232. One example of the stored contents of the snapshot use information 610 will be described with FIG. 7.

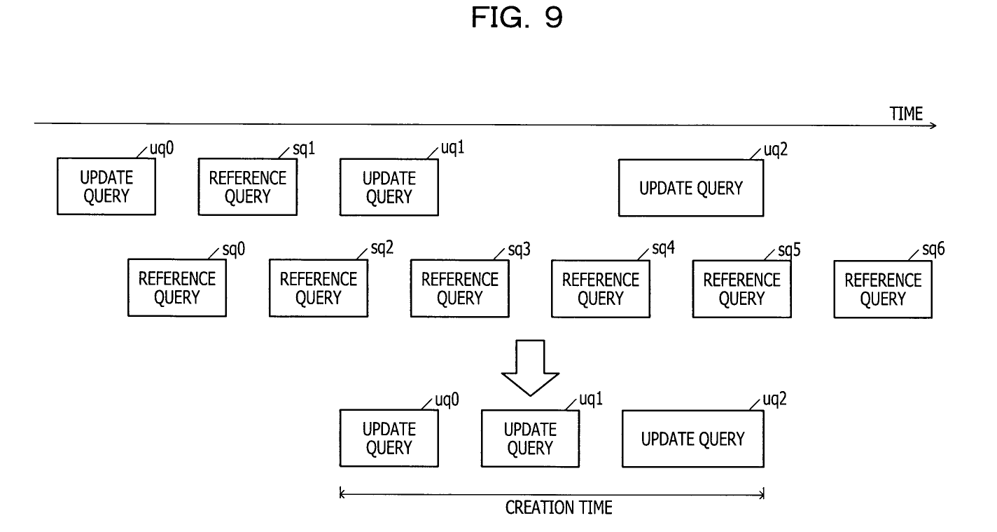

The identifying unit 601 refers to the SQL query storage unit 221 and identifies the processing time of the SQL query accepted by the DB server 232 from the time of another snapshot different from one snapshot of plural snapshots by the time of this one snapshot. The processing time of the SQL query may be the processing time of a query to update the DB server 232 among all SQL queries. A specific identifying method will be described with FIG. 9.

The deciding unit 602 decides the snapshot to be deleted from the plural snapshots on the basis of the creation time identified by the identifying unit 601. The method for the decision may be absolute comparison with use of a threshold. Alternatively, if plural creation times exist as the creation times identified by the identifying unit 601, the deciding unit 602 may decide the snapshot having the shortest creation time among the plural snapshots as the snapshot to be deleted.

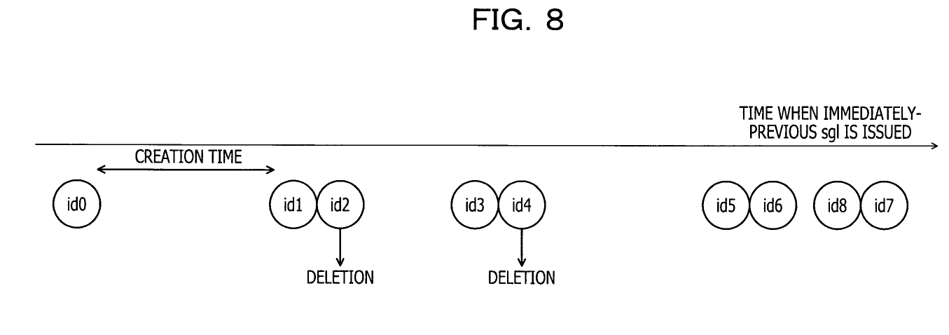

Furthermore, the deciding unit 602 may decide the snapshot to be deleted from the plural snapshots on the basis of the time identified by the identifying unit 601 and the time when the snapshot is used to restore the contents of the DB server 232, stored in the snapshot use information 610. For example, the deciding unit 602 decides the snapshot to be deleted in accordance with the least recently used (LRU) algorithm. For example, if the times when the snapshot is used to restore the contents of the DB server 232 are equivalent, the deciding unit 602 may decide the snapshot having a smaller number of times of being used to restore the contents of the DB server 232 as the snapshot to be deleted. A specific example of the decision of the snapshots to be deleted will be described with FIG. 8.

The deleting unit 603 deletes the snapshot decided by the deciding unit 602 from the snapshot storage unit 222.

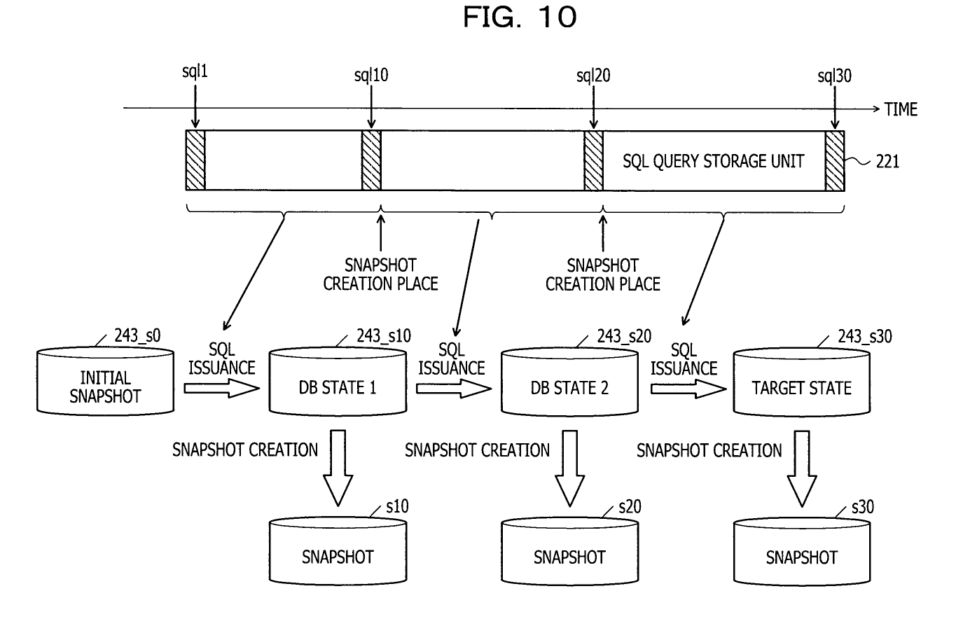

The classifying unit 604 refers to the SQL query storage unit 221 and classifies the SQL queries stored by the SQL query storage unit 221 into plural groups in accordance with the times of the SQL queries. Corresponding to each group of the plural groups classified by the classifying unit 604, the creating unit 605 creates a snapshot obtained by duplicating the contents of the DB obtained by issuing the SQL queries belonging to each group. Here, the issuance destination of the SQL queries is the DB including the contents at the time of the first SQL query among the processing requests belonging to each group, and is e.g. the test DB server 243. The method for the classification and the method for creating the snapshots will be described with FIG. 10.

FIG. 7 is an explanatory diagram illustrating one example of stored contents of snapshot use information. The snapshot use information 610 is information to manage snapshots. The snapshot use information 610 illustrated in FIG. 7 includes records 701-0 to 701-8.

The snapshot use information 610 includes fields of immediately-previous sql of snapshot, test use time, and snapshot ID. In the field of immediately-previous sql of snapshot, identification information of the SQL query issued immediately previous to the DB server 232 at the duplication time point of the corresponding snapshot is stored. In the field of test use time, the time when the corresponding snapshot is used to restore the contents of the DB server 232 is stored. In the field of snapshot ID, identification information of the corresponding snapshot is stored.

Here, for simplification of description, suppose that sql0 is issued at the oldest time among sql0 to sql8 in the snapshot use information 610 illustrated in FIG. 7 and the time of the issuance becomes newer in ascending order and sql8 indicates the newest issuance. Similarly, suppose that t0 is the oldest time among t0 to t8 in the snapshot use information 610 illustrated in FIG. 7 and the time becomes newer in ascending order and t8 is the newest time.

For example, the snapshot use information 610 indicates that the snapshot id8 is used at t8, which is the latest time. However, the SQL query issued immediately previous to the DB server 232 at the duplication time point of the snapshot id8 is sql7 and is issued at an older time than the SQL query sql8 corresponding to the snapshot id7.

Furthermore, the DB restoring device 211 also manages the initial snapshot by using the snapshot use information 610. At this time, in order to indicate that this snapshot is the initial snapshot, the snapshot use information 610 stores a flag indicating that this snapshot is the initial snapshot in association with the snapshot ID although not represented in FIG. 7. Suppose that the snapshot id0 is the initial snapshot in the example of FIG. 7.

FIG. 8 is an explanatory diagram illustrating an example of decision of snapshots to be deleted. In FIG. 8, an example of deciding the snapshots to be deleted will be described. Here, suppose that snapshots saved in the snapshot storage unit 222 are the snapshots id0 to id8 represented in FIG. 7. Moreover, the snapshot id0 as the initial snapshot is excluded from the deletion target. Furthermore, in the example of FIG. 8, assuming that up to seven snapshots are saved, a method for deciding two snapshots to be deleted from the snapshots id1 to id8 will be described.

In FIG. 8, the snapshots id0 to id8 are lined in the order of the time when the immediately-previous sql is issued. As illustrated in FIG. 8, the snapshots id0 to id6, id8, and id7 are lined in chronological order of the issuance of the immediately-previous sql. Moreover, as illustrated in FIG. 8, the interval from the time of the duplication time point of the previous snapshot to the time of the duplication time point of a certain snapshot indicates the length of the creation time of the certain snapshot. The method for identifying the creation time of the snapshot will be described with FIG. 9. As illustrated in FIG. 8, the creation time of the snapshots id1 and id5 is the longest and the creation time of the snapshot id3 is the second longest. Furthermore, the creation time of the snapshot id8 is the third longest and the creation time of the snapshots id2, id4, id6, and id7 is the shortest.

First, the DB restoring device 211 selects n [%] from the snapshot whose last time of the use for restoring is the oldest. n [%] is a value decided by an administrator of the DB restoring device 211. In the example of FIG. 8, the snapshots id1 to id4, whose test use times are t1 to t4, are selected in chronological order of the last time of the use for restoring. By deleting snapshots from the snapshot whose last time of the use for restoring is the oldest in this manner, snapshots recently used for restoring can be left. Furthermore, from a rule of thumb that, when a trouble in the production system 201 is corrected, a problem readily occurs again at the corrected place, the creation time of the snapshot can be shortened by leaving the snapshots recently used for restoring.

Furthermore, in the middle of access reproduction, in order to narrow down the reproduction target more finely, the reproduction is often carried out from a time slightly subsequent to the specified time. In this case, because the snapshot slightly subsequent to the specified time can be quickly made from the snapshot of the specified time, the DB restoring device 211 can shorten the creation time of the snapshot by leaving the snapshot of the specified time.

Then, the DB restoring device 211 decides the snapshots id2 and id4, whose creation time is short, among the selected snapshots id1 to id4 as the snapshots to be deleted. In this manner, snapshots with a short creation time are treated as the deletion target in consideration of the trouble of creation in the future. This shortens the average creation time in the DB restoring device 211.

FIG. 9 is an explanatory diagram illustrating one example of a method for identifying creation time of a snapshot. In the example of FIG. 9, the method for identifying the creation time of a certain snapshot will be described by using an example in which reference queries sq0 to sq6 and update queries uq0 to uq2 are issued from the time of the duplication time point of the previous snapshot by the time of the duplication time point of the certain snapshot. Furthermore, suppose that, in FIG. 9, the horizontal width of the reference queries sq0 to sq6 and the update queries uq0 to uq2 indicates the processing time of each query. Here, the reference query is a query to make reference to the DB server 232 and is e.g. a SELECT sentence or the like. Furthermore, the update query is a query to carry out update on the DB server 232 and is e.g. an UPDATE sentence, an INSERT sentence, or a DELETE sentence.

The DB restoring device 211 identifies the time obtained by summing the processing times of the SQL queries as the creation time of the snapshot. Furthermore, the DB restoring device 211 may identify the processing times of the update SQL queries among the SQL queries as the creation time of the snapshot. For example, if the DB server 232 is a DB that simultaneously accepts and processes SQL queries, the DB restoring device 211 executes the processing on the basis of the assumption that the processing time of the update SQL query does not change even when another reference SQL query simultaneously processed is excluded. Actually there is a possibility that excluding the reference SQL query shortens the processing time of the update SQL query. However, the amount of time shortening is small relative to the processing time of the update SQL query and does not have to be exactly obtained. Furthermore, even with an asynchronous update SQL query, the processing time of the asynchronous update SQL query does not change.

Regarding the processing time of the SQL query, the DB restoring device 211 defines e.g. the time obtained by subtracting the request time of the SQL query from the response time as the processing time of the SQL query. Alternatively, suppose that it is apparent from the specifications of the production system 201 that the processing time of the SQL query issued in the production system 201 is substantially steady. In this case, the DB restoring device 211 may employ a predetermined value as the processing time of the SQL query.

In the example of FIG. 9, the DB restoring device 211 employs the time obtained by summing the processing times of the update queries uq0 to uq2 as the creation time of the certain snapshot.

FIG. 10 is an explanatory diagram illustrating one example of a speculative method for creating snapshots. Suppose that, in the example of FIG. 10, only an initial snapshot is saved in the snapshot storage unit 222 and the contents of the test DB server 243 are in the state of the initial snapshot. In the description of FIG. 10, the test DB server 243 is represented as the test DB server 243_sx. The tail symbol “sx” corresponds with the symbol of the snapshot according with the contents of the test DB server 243. Furthermore, suppose that the SQL query storage unit 221 saves update SQL queries sql1 to sql30. In addition, for simplification of description, suppose that the processing times of sql1 to sql30 are the same.

The DB restoring device 211 identifies, as the number of snapshots that can be saved, a value obtained by dividing a value resulting from subtraction of the present data amount of the snapshot storage unit 222 from the amount of data that can be saved in the snapshot storage unit 222 by the data amount of the snapshot per one snapshot. Suppose that the DB restoring device 211 identifies the number of snapshots that can be saved as three in the example of FIG. 10.

Next, the DB restoring device 211 decides the update SQL queries corresponding to the timing of saving of a snapshot from the processing time of sql so that the three snapshots to be created may be evenly distributed. In the example of FIG. 10, the DB restoring device 211 decides sql10, sql20, and sql30 as the update SQL queries corresponding to the timing of saving of a snapshot.

Next, the DB restoring device 211 issues sql1 to sql10 to a test DB server 243_s0. Thereby, the DB restoring device 211 creates a snapshot s10 obtained by duplicating the contents of a test DB server 243_s10 that has become DB state 1. Similarly, the DB restoring device 211 issues sql11 to sql20 to the test DB server 243_s10. Thereby, the DB restoring device 211 creates a snapshot s20 obtained by duplicating the contents of a test DB server 243_s20 that has become DB state 2. Similarly, the DB restoring device 211 issues sql21 to sql30 to the test DB server 243_s20. Thereby, the DB restoring device 211 creates a snapshot s30 obtained by duplicating the contents of a test DB server 243_s30 that has become the target state.

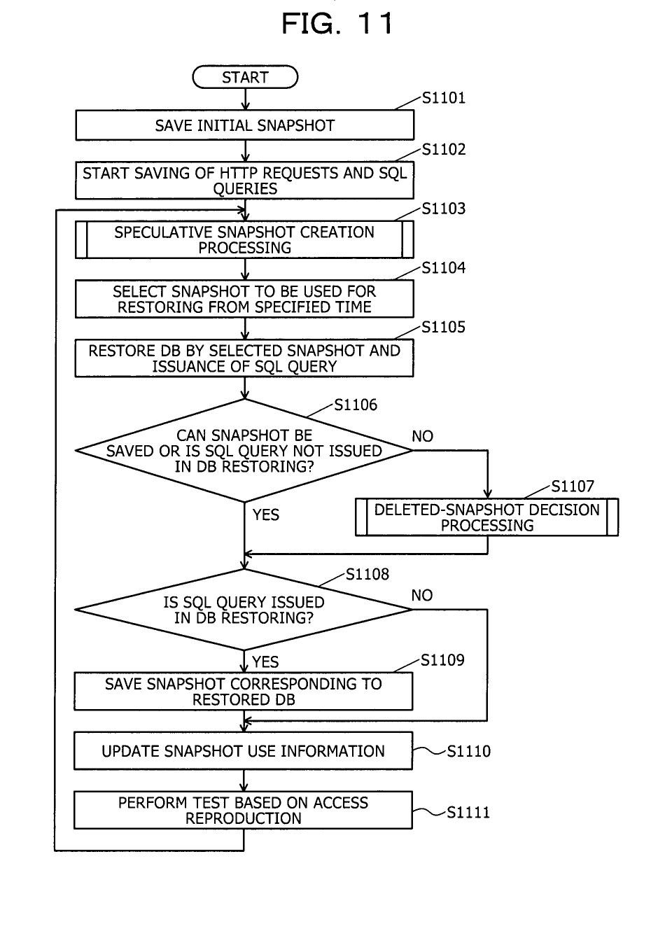

Next, flowcharts representing processing executed by the access reproduction system 200 will be described by using FIGS. 11 to 14.

FIG. 11 is a flowchart illustrating one example of a procedure of access reproduction processing. The access reproduction processing is processing of reproducing a state in the production system 201 at a time point specified by a verifier by the test system 202.

The DB restoring device 211 saves an initial snapshot (S1101). Next, the access reproduction system 200 starts saving of HTTP requests and SQL queries (S1102). Regarding the processing of S1102, for example, the HTTP request storage device 213 starts saving of HTTP requests and the DB restoring device 211 starts saving of SQL queries.

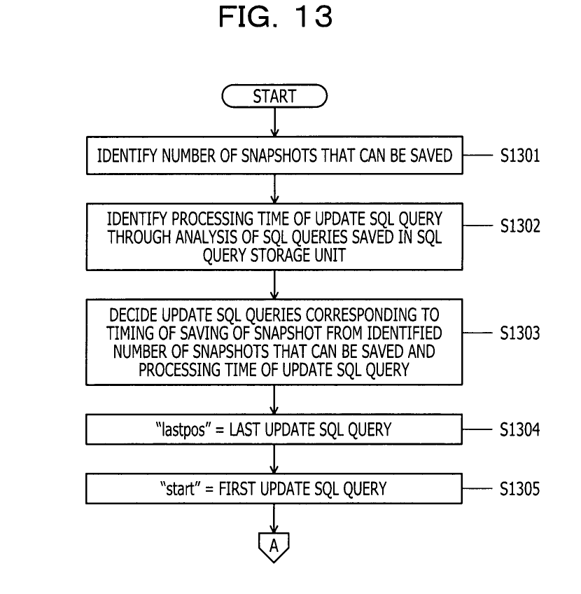

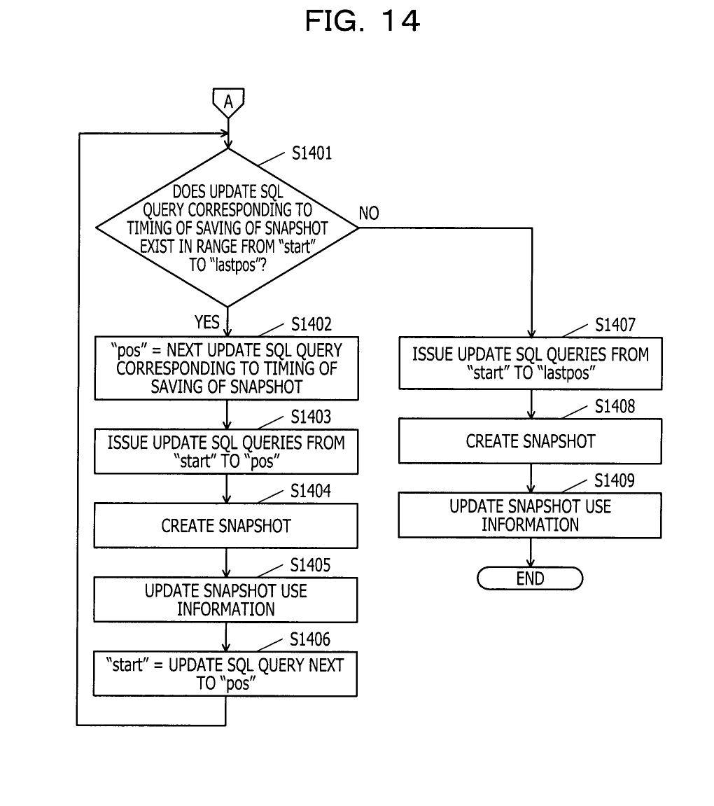

After the elapse of a certain time from the processing of S1102, the DB restoring device 211 executes speculative snapshot creation processing (S1103). Details of the speculative snapshot creation processing will be described with FIGS. 13 and 14. The DB restoring device 211 does not have to execute the processing of S1103. Next, suppose that the verifier terminal 215 transmits an instruction to reproduce the state to the access reproduction control device 212 after the end of the processing of S1103. At this time, when receiving a DB reproduction instruction from the access reproduction control device 212, the DB restoring device 211 selects the snapshot to be used for restoring from the specified time (S1104).

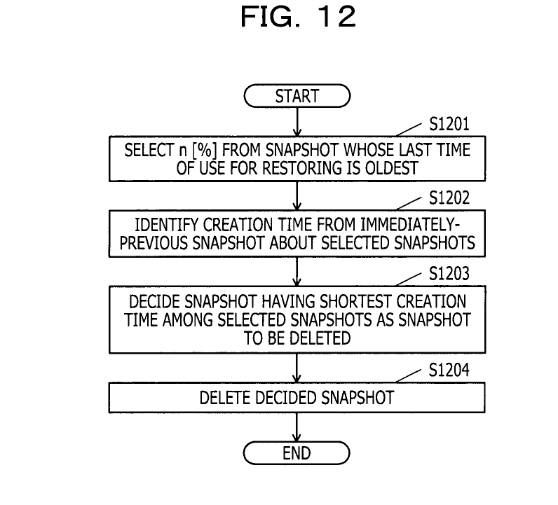

Then, the DB restoring device 211 restores the DB by the selected snapshot and issuance of the SQL query (S1105). Next, the DB restoring device 211 determines whether or not the snapshot can be saved or the SQL query is not issued in the DB restoring (S1106). If it is difficult to save the snapshot and the SQL query is issued in the DB restoring (S1106: No), the DB restoring device 211 executes deleted-snapshot decision processing (S1107). Details of the deleted-snapshot decision processing will be described with FIG. 12.

After the end of the processing of S1107 or if the snapshot can be saved or the SQL query is not issued in the DB restoring (S1106: Yes), the DB restoring device 211 determines whether or not the SQL query is issued in the DB restoring (S1108). If the SQL query is issued in the DB restoring (S1108: Yes), the DB restoring device 211 saves the snapshot corresponding to the restored DB (S1109).

After the end of the processing of S1109 or if the SQL query is not issued in the DB restoring (S1108: No), the DB restoring device 211 updates the snapshot use information (S1110). Then, the access reproduction control device 212 performs a test based on access reproduction (S1111). After the end of the processing of S1111, the access reproduction system 200 makes transition to the processing of S1103. By executing the access reproduction processing, the DB restoring device 211 can reproduce the state in the production system 201 at the time point specified by the verifier by the test system 202 and the verifier can carry out verification.

FIG. 12 is a flowchart illustrating one example of a procedure of deleted-snapshot decision processing. The deleted-snapshot decision processing is processing of deleting a snapshot from the snapshots saved in the snapshot storage unit 222.

The DB restoring device 211 selects n [%] from the snapshot whose last time of the use for restoring is the oldest (S1201). Next, the DB restoring device 211 identifies the creation time from the immediately-previous snapshot about the selected snapshots (S1202). Then, the DB restoring device 211 decides the snapshot having the shortest creation time among the selected snapshots as the snapshot to be deleted (S1203). Then, the DB restoring device 211 deletes the decided snapshot (S1204). After the end of the processing of S1204, the DB restoring device 211 ends the deleted-snapshot decision processing. By executing the deleted-snapshot decision processing, the DB restoring device 211 reduces the data amount of the snapshot storage unit 222 and can suppress increase in the restoring time of the DB.

FIG. 13 is a flowchart (first) illustrating one example of a procedure of speculative snapshot creation processing. Furthermore, FIG. 14 is a flowchart (second) illustrating one example of a procedure of speculative snapshot creation processing. The speculative snapshot creation processing is processing of speculatively creating snapshots.

The DB restoring device 211 identifies the number of snapshots that can be saved (S1301). Next, the DB restoring device 211 identifies the processing time of the update SQL query through analysis of the SQL queries saved in the SQL query storage unit 221 (S1302). Then, the DB restoring device 211 decides the update SQL queries corresponding to the timing of saving of a snapshot from the identified number of snapshots that can be saved and the processing time of the update SQL query (S1303). Next, the DB restoring device 211 sets “lastpos” to the last update SQL query (S1304). Then, the DB restoring device 211 sets “start” to the first update SQL query (S1305).

Next, the DB restoring device 211 determines whether or not the update SQL query corresponding to the timing of saving of a snapshot exists in the range from “start” to “lastpos” (S1401). If the update SQL query corresponding to the timing of saving of a snapshot exists (S1401: Yes), the DB restoring device 211 sets “pos” to the next update SQL query corresponding to the timing of saving of a snapshot (S1402). Next, the DB restoring device 211 issues the update SQL queries from “start” to “pos” to the test DB server 243 (S1403). Then, the DB restoring device 211 duplicates the contents of the test DB server 243 to create a snapshot (S1404). The DB restoring device 211 saves the created snapshot in the snapshot storage unit 222. Next, the DB restoring device 211 updates the snapshot use information 610 (S1405).

Then, the DB restoring device 211 sets “start” to the update SQL query next to “pos” (S1406). Regarding the processing of S1405, the identification information of the SQL query indicated by “pos” is stored in the field of immediately-previous sql of snapshot. Nothing is stored in the field of test use time and an empty field is left. Next, the DB restoring device 211 makes transition to the processing of S1401.

On the other hand, if the update SQL query corresponding to the timing of saving of a snapshot does not exist (S1401: No), the DB restoring device 211 issues the update SQL queries from “start” to “lastpos” to the test DB server 243 (S1407). Next, the DB restoring device 211 duplicates the contents of the test DB server 243 to create a snapshot (51408). The DB restoring device 211 saves the created snapshot in the snapshot storage unit 222. Then, the DB restoring device 211 updates the snapshot use information 610 (S1409). Regarding the processing of S1409, the identification information of the SQL query indicated by “lastpos” is stored in the field of immediately-previous sql of snapshot. Nothing is stored in the field of test use time and an empty field is left.

After the end of the processing of S1409, the DB restoring device 211 ends the speculative snapshot creation processing. By executing the speculative snapshot creation processing, the DB restoring device 211 can shorten the average value of the restoring time of the DB.

As described above, according to the DB restoring device 211, the snapshot to be deleted is decided from plural snapshots on the basis of the processing time of the SQL query received between the creation time points of the respective snapshots, i.e. the creation time of the snapshot. This allows the management device 101 to suppress increase in the restoring time of the contents of the DB server 232 while deleting the snapshot that can be quickly made to reduce the data amount. Furthermore, the DB restoring device 211 can create the snapshot without imposing a burden on the production system 201. Even if a stop for several seconds for creating the snapshot is permitted in the production system 201, it is difficult to save the snapshot at arbitrary timing. In contrast, the DB restoring device 211 can save the snapshot at arbitrary timing.

Furthermore, according to the DB restoring device 211, the snapshot to be deleted may be decided on the basis of the creation time of the snapshot and the test use time of the snapshot. Due to this, from a rule of thumb that, when a trouble in the production system 201 is corrected, a problem readily occurs again at the corrected place, the DB restoring device 211 can shorten the creation time of the snapshot by leaving the snapshots recently used for restoring.

Moreover, according to the DB restoring device 211, the snapshot may be speculatively created with reference to the SQL query storage unit 221. This allows the DB restoring device 211 to shorten the average value of the restoring time of the DB. Furthermore, the snapshot speculatively created is readily deleted because the field of test use time is empty. Therefore, a situation does not occur in which a snapshot frequently used is deleted due to the snapshot speculatively created.

The snapshot management method described in the present embodiment can be implemented by executing a program prepared in advance by a computer such as a personal computer, a workstation or the like. The present snapshot management program is recorded in a computer-readable recording medium such as a hard disk, a flexible disk, a compact disc-read only memory (CD-ROM), or a digital versatile disk (DVD) and is read out from the recording medium by the computer to be executed. Furthermore, the present snapshot management program may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An apparatus comprising:
a first memory configured to store a plurality of snapshots of a database, each of the plurality of snapshots being obtained by duplicating contents of the database at a different time;
a second memory configured to store correspondence information for each of processing requests to the database, the correspondence information including time information at which each of the processing requests is accepted by the database in association with a time period taken for processing each of the processing requests; and
a processor coupled to the first memory and the second memory and configured to:
identify a total time period to process processing requests received by the database from a first time at which a first snapshot is obtained to a second time at which a second snapshot is obtained, the first snapshot and the second snapshot being included in the plurality of snapshots;
decide a snapshot to be deleted from the plurality of snapshots based on the identified total time period; and
delete the decided snapshot from the first memory.

2. The apparatus according to claim 1, wherein the processor is further configured to:
store time information in the second memory, the time information indicating a time when one of the plurality of snapshots is used to restore the contents of the database, and
decide the snapshot to be deleted from the plurality of snapshots based on the time information and the identified total time period.

3. The apparatus according to claim 1, wherein the processor is further configured to:
classify the processing requests accepted by the database into a plurality of groups based on the correspondence information and each accepted time of the accepted processing requests accepted; and
create, corresponding to each of the classified plurality of groups, a snapshot obtained by duplicating contents of the database including contents at a time of a earliest processing request among the processing requests belonging to the each group and by processing the processing requests belonging to the each group to the duplicated contents of the database.

4. A system comprising
the apparatus according to claim 1; and
a storage device configured to store the database.

5. A snapshot management method comprising:
storing a plurality of snapshots of a database in a first memory, each of the plurality of snapshots being obtained by duplicating contents of the database at a different time;
storing correspondence information for each of processing requests to the database in a second memory, the correspondence information including time information at which each of the processing requests is accepted by the database in association with a time period taken for processing each of the processing requests;
identifying, by a processor, a total time period to process processing requests received by the database from a first time at which a first snapshot is obtained to a second time at which a second snapshot is obtained, the first snapshot and the second snapshot being included in the plurality of snapshots;
deciding, by the processor, a snapshot to be deleted from the plurality of snapshots based on the identified total time period; and
deleting, by the processor, the decided snapshot from the first memory.

6. The method according to claim 5, further comprising:
storing time information in the second memory, the time information indicating a time when one of the plurality of snapshots is used to restore the contents of the database; and
deciding, by the processor, the snapshot to be deleted from the plurality of snapshots based on the time information and the identified total time period.

7. The method according to claim 5, further comprising:
classifying the processing requests accepted by the database into a plurality of groups based on the correspondence information and each accepted time of the accepted processing requests accepted; and
creating, by the processor, corresponding to each of the classified plurality of groups, a snapshot obtained by duplicating contents of the database including contents at a time of a earliest processing request among the processing requests belonging to the each group and by processing the processing requests belonging to the each group to the duplicated contents of the database.

8. A non-transitory computer readable medium having stored therein a program that causes a computer to execute a process, the process comprising:
storing a plurality of snapshots of a database in a first memory, each of the plurality of snapshots being obtained by duplicating contents of the database at a different time;
storing correspondence information for each of processing requests to the database in a second memory, the correspondence information including time information at which each of the processing requests is accepted by the database in association with a time period taken for processing each of the processing requests;
identifying a total time period to process processing requests received by the database from a first time at which a first snapshot is obtained to a second time at which a second snapshot is obtained, the first snapshot and the second snapshot being included in the plurality of snapshots;
deciding a snapshot to be deleted from the plurality of snapshots based on the identified total time period; and
deleting the decided snapshot from the first memory.

9. The non-transitory computer readable medium according to claim 8, wherein the process further comprising:
storing time information in the second memory, the time information indicating a time when one of the plurality of snapshots is used to restore the contents of the database; and
deciding the snapshot to be deleted from the plurality of snapshots based on the time information and the identified total time period.

10. The non-transitory computer readable medium according to claim 8, wherein the process further comprising:
classifying the processing requests accepted by the database into a plurality of groups based on the correspondence information and each accepted time of the accepted processing requests accepted; and
creating, corresponding to each of the classified plurality of groups, a snapshot obtained by duplicating contents of the database including contents at a time of a earliest processing request among the processing requests belonging to the each group and by processing the processing requests belonging to the each group to the duplicated contents of the database.
